(19) United States
(12) Patent Application Publication
(10) Pub. No.: US 2009/0015057 A1
(43) Pub. Date: Jan. 15, 2009

(54) Display device for hub caps

(76) Inventor: David W. Groomes, Dayton, OH (US)

Correspondence Address: William M. Selenke, 5 Drummond St., Cincinnati, OH, 45218, US

(21) Appl. No.: 11/804,640

(22) Filed: May 19, 2007

(51) Int. Cl. B60B 7/00; B60Q 1/00; B60Q 1/26

(52) U.S. Cl. 301/37.108; 362/500

(57) ABSTRACT

A video display made by light emitting diodes (LEDS), liquid crystal displays (LCD) or digital light processing displays (DLP) is mounted on the specialty hubcap. The video display is maintained in an up down position as the automobile moves. The device is cooled with vanes, thermoelectric cooler, or radiator plate. The device is powered by wheel generators or from the car battery. Manual or electronic controls manage the video sources which can be VCR, DVD, or ordinary video TV as well as a computer video source.

### FIELD OF INVENTION

The invention is concerned with novelty hubcaps for vehicles such as automobiles and trucks. More specifically, the invention is concerned with displays of detailed illustrations on the surface of hubcaps using light emitting diodes (LEDS), liquid crystal displays (LCD) digital light processing displays (DLP) or other current technology. Later use of the term display will refer to anyone of known display technologies.

### BACKGROUND OF INVENTION

In America, many subgroups of usually young adult males have a great interest and spent time customizing their automobiles and light trucks into show pieces. A common feature of such customized automobiles is the use of novelty hubcaps. In some instances the hubcaps are ordinary hubcaps that are highly polished and have novelty ornamental features. In the recent past the “spinning” hubcaps have become common ornamental features for customized automobiles. That is the hubcaps are not firmly affixed to the wheel hub, but the hubcap rotates independently of the movement of the wheels.

The present invention is concerned with such novelty hubcaps wherein the novelty consists of a display of a detailed picture or video on the hubcaps. It is a further feature that such picture or video are created by LED's or other display method to present an actual picture or video.

The present invention is a moving visual display that is mounted in the core of a wheel to act as a hub cap. The invention has a mounting bracket which is affixed to the hub of the wheel. Removably affixed to the center of that mounting bracket is a series of discs with grooves for ball bearings to allow any device mounted to remain stationary as the wheel rotates. The invention has several cooling means including air vents with vanes so that as the car moves the air vents with vanes forces air over the heated hubcaps. Likewise, a second means of cooling the device is a thermoelectric sink. Mounted in the core of the device that remains stationary is a display, LCD optionally a LED display. Associated with the display is a video receiver as well as controls to adjust the input on the LED display. The invention may be powered either by a battery and generator or by electricity which is transferred via contacts to wires which go through the body of the wheel. Internal contacts transfer electricity to the stationary device.

### SUMMARY OF INVENTION

A display which provides a moving picture or illustration on the hubcap of an automobile has a display wheel mount with a cone cylinder and an axle depression void and as well as cylindrical extensions with holes for lug bolts. The cone cylinder has a housing cylinder with an attachment ring to retain a free wheeling bearing device. A circular mounting plate is affixed to freewheeling bearing device through mounting plate hole into a T-spacer. In turn, a thermoelectric cooler and radiator plate is fastened to the mounting plate and a heatsink is affixed to the thermoelectric cooler and radiator plate. The heatsink has an outer ridge and an inner ridge with a power means. Likewise, the inventive unit has a video source, a video receiver, and display control. There is a means to keep the video display in an updown position. The device is covered by an attached Plexiglas™ or Lexan™ cover; The free wheeling bearing device is a plate bearing device or a roller bearing. Additional cooling means are vanes on the wheel. The device can be powered by a dry battery, a wheel movement powered generator, or a slipring connectors with wires which allows power from the car battery. The video source is a video link to a VCR, DVD, or ordinary video TV as well as computer video sources. The display control is a manual control device or electronically controlled device via radio or infrared signals. The video display is kept in an updown position with a counterweight rotation inhibiting mass or an electric motor timed to spin at the same time the wheel spins. The displays of detailed illustrations on the surface of hubcaps use light emitting diodes (LEDS), liquid crystal displays (LCD) or digital light processing displays (DLP).

### BRIEF DESCRIPTION OF FIGURES

The Diagram is a schematic outline of the invention to provide an overall look at the elements of the present invention.

FIG. 1 shows a perspective view of the assembled invention.

FIG. 2 A) shows a head on view of the invention looking from the outside to the car wheel. B) illustrates a cross-section of the customized wheel of a car that received invention. C) is a view of the wheel hub from the inside out.

FIG. 3 shows display wheel mount head on view A and a section view B mounted on core of wheel.

FIG. 4 shows an exploded view of the invention.

FIG. 5 shows detail of T-spacer.

FIG. 6 shows head on view of heatsink.

FIG. 7 shows an alternative bearing means, a roller bearing.

FIG. 8 illustrates an embodiment with a wheel movement powered generator.

### DETAILED DESCRIPTION OF INVENTION

The Diagram is a schematic outline of the invention to provide an overall look at the elements of the present invention. In broad outline A shows a tire, B shows the hub, and C shows video display which is the object of the present invention. The inventive device provides a moving picture or illustration on the rectangle C in the central part of the hubcap. The elements required for the present invention are D which is a bearing device to allow freewheeling. Examples of bearing devices are roller bearings and plate bearings. E is a means to maintain the moving picture in a stationary matter, up and down. This up down orientation is provided by a counterweight or an electric motor timed to spin at the same time the wheel spins allowing the display to be stationary. Such a device is called a stepper motor or servo motor. F is a power source for the device. The power source can be the automobile battery transferring electricity through the wheel by means of brushes. A second source is an ordinary disposable battery. A third source is a rechargeable battery that is recharged by a generator that is activated as the inventive device remains still relative to the motion of the turning tire. G is a cooling means to prevent excess heat buildup caused by the movement of the wheel and other heat sources. These cooling means are vanes on the wheel, a heatsink, and/or a thermoelectric refrigerator. Element H is the video signal source. H is the signal source for the video display C of the invention. Signal sources can be via radio video link to a VCR, DVD or ordinary video TV as well as computer video sources. J is a transforming and transferring means to process a signal from the source of the pictures transferring them to the display panel. K is the device to control the series of pictures. These can be controlled by either a manual control device or electronically controlled via radio or infrared signals to be illuminated on video display. It is to be understood that these are the basic elements of the invention. However, other equivalent means could usefully help process the current invention.

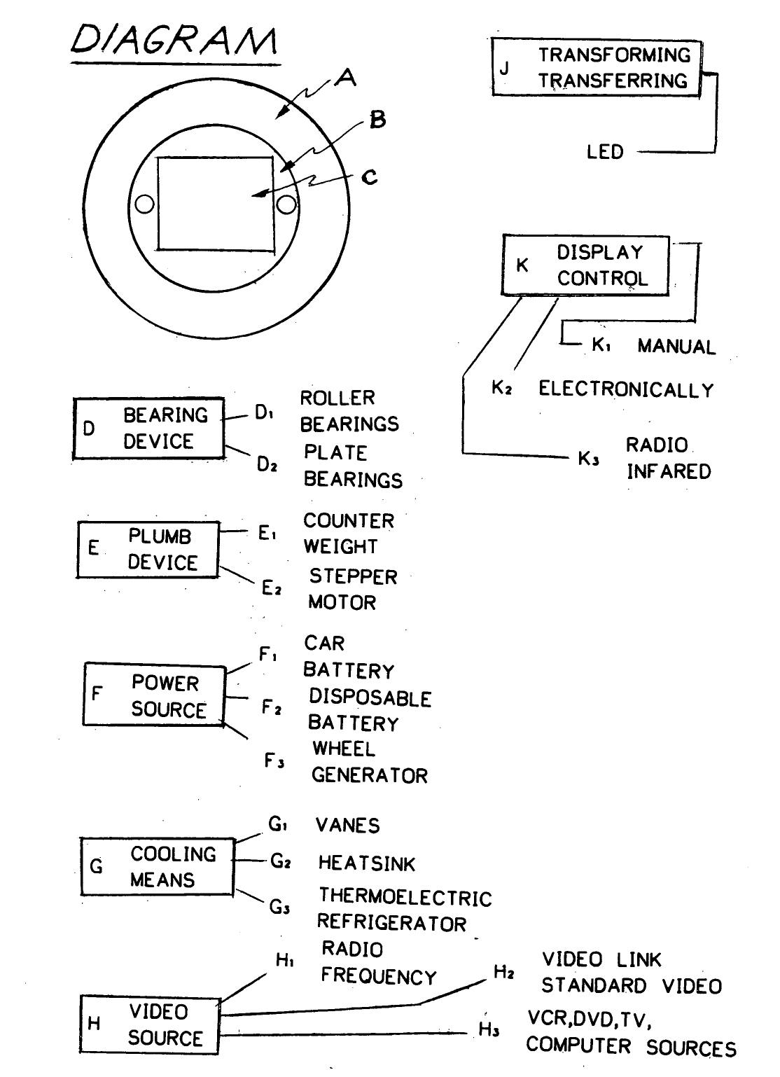

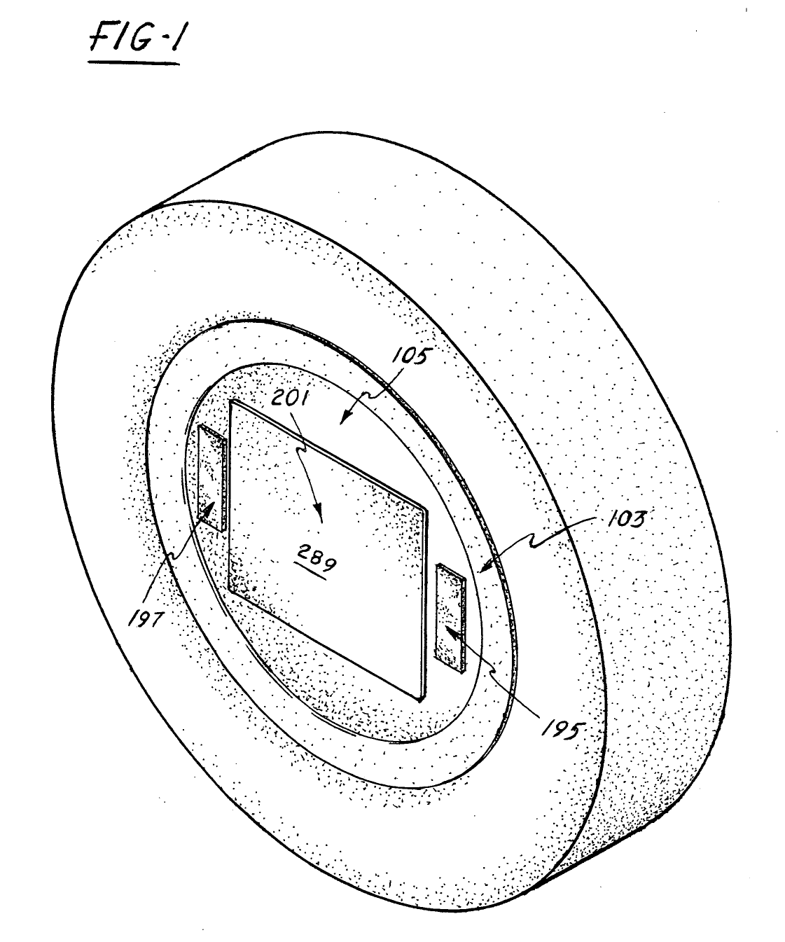

FIG. 1 shows a perspective view of the assembled invention 201. In the central part of the invention is the LCD display covered with Plexiglas 289. Workpiece outer rim 103 and workpiece outer wheel wall 105 are shown. Manual control switch is shown as 195. Electronic controls to receive instructional infra red or radio control signals is 197

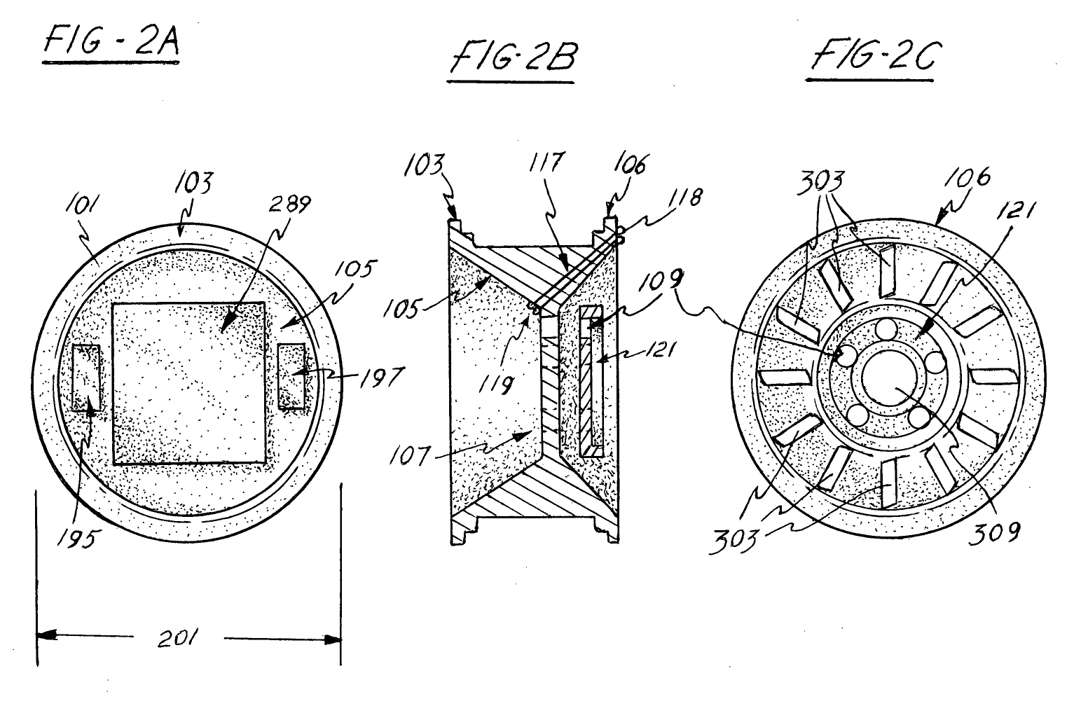

FIG. 2 A) shows a head on view of the invention 201 looking from the outside to the car wheel. B) illustrates a cross-section of the customized wheel of a car that received invention. C) is a view of the wheel hub from the inside out. In detail, A) the wheel 101 has an outer rim 103, an outer wheel wall curvature 105, and Plexiglas cover 289. Manual control switch is shown as 195. Electronic controls to receive instructional infra red or radio control signals is 197. B) is a cross-section through the center of the wheel hub. Outer tire rim holder 103 and inner tire rim holder 106 are shown. The inner curvature 105 for the tire wheel is shown. Lug bolt hole(s) 109 are shown in mounting plane 107. The customized wheel has an inner pair of sliprings 119 connects with wires 117 which allows power from the car battery to be transferred via outer sliprings 118 to the stationary display device. View C) shows an inner view of the wheel hub 10. Inner rim holder 103 terminates inwardly to tire mounting hub plane 121 with holes 109. Cooling vanes 303 are present. Core opening for wheel axle is 309.

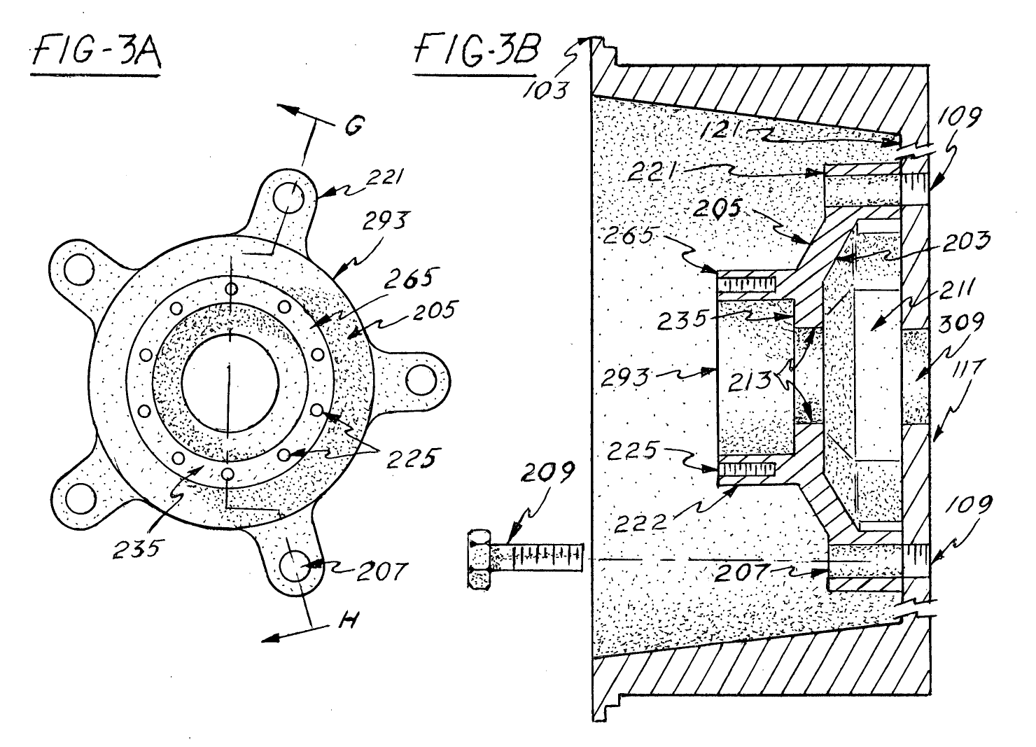

FIG. 3 shows display wheel mount 293 head on view A and a section view B mounted on core 117 of wheel. Offset arrows G and H illustrate section view B. Display wheel mount 293 has cone cylinder 205 with axle depression void 211. Cone cylinder has cylindrical extensions 221 with holes 207 for workpiece lug bolts 209. Inner side 203 of depression void 211 terminates in axle depression base 213. Cone cylinder 205 has a first progression to make housing cylinder 222 which housing cylinder 222 houses free wheeling bearing device 231. Likewise, a second progression of cone cylinder 205 extends inwardly as inner support 235 of axle depression base. Housing cylinder mounting plane 265 has screw holes 225. Outer rim holder 106 terminates inwardly to tire mounting hub plane 121 with holes 109. Core opening for wheel axle is 309.

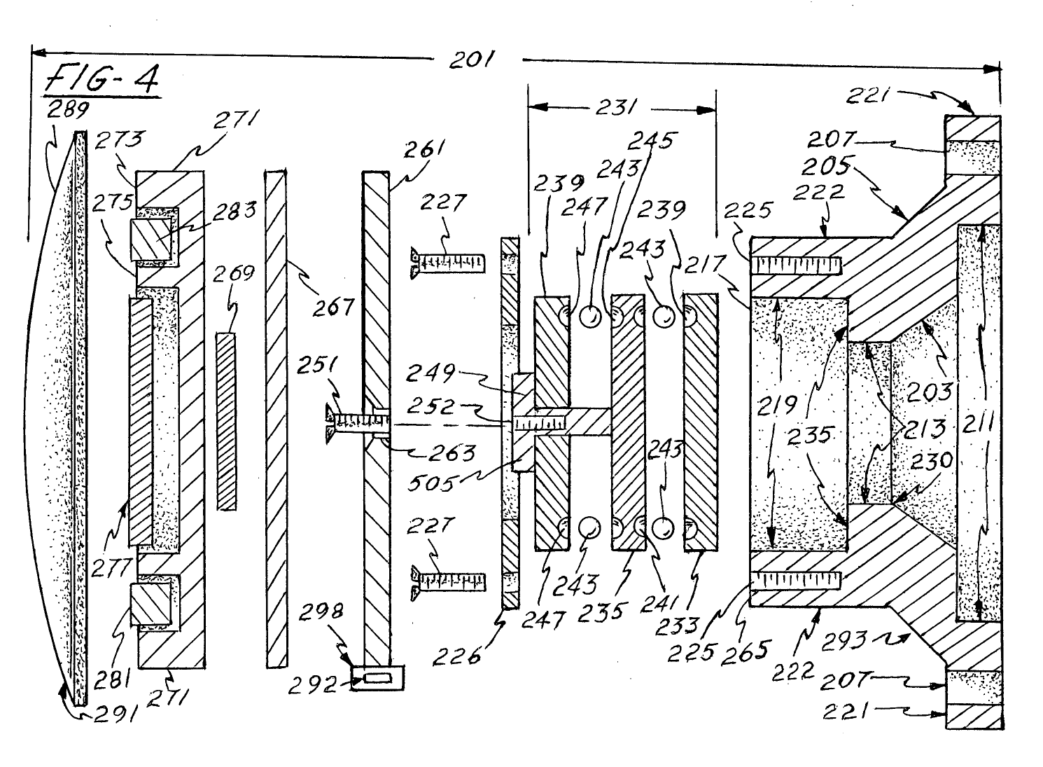

FIG. 4 shows an exploded view of the invention 201. Display wheel mount 293 cast section view shows that display wheel mount 203 has cone cylinder 205 with axle depression void 211. Cone cylinder 205 has outer cylindrical extensions 221 with holes 207 for workpiece lug bolts 209. Inner side 230 of depression void 211 terminates in inner support 235 of axle depression base 213. Cone cylinder 205 has a first progression to make housing cylinder 222 which housing cylinder 222 surrounds free wheeling bearing device 231. Likewise, a second progression of cone cylinder 205 extends inwardly as inner support 235 of axle depression base. Housing cylinder 222 ends in housing cylinder mounting plane 265 which has screw holes 225.

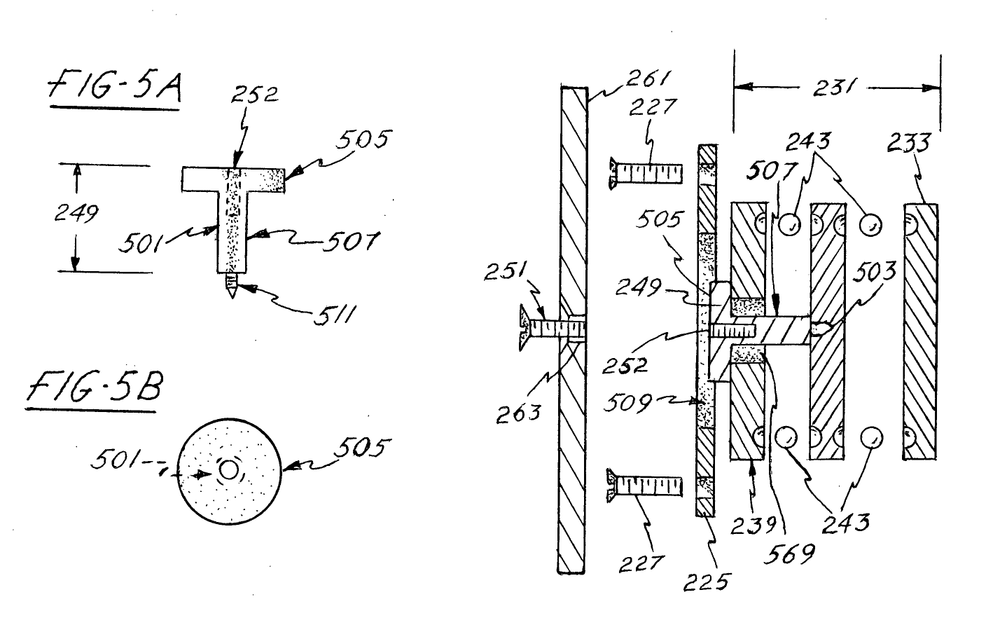

Attachment ring 226 is affixed to mounting plane 265 of housing cylinder 222 with screws 227. Attachment ring 226 encloses freewheeling plate bearing device 231 which is a means to prevent display 277 rotation when wheel of auto is turning. Freewheeling plate bearing device 231 has an inner disk 233, a middle disk 235, and an outer disk 239. Inner disk 233 as a ball bearing groove 239. Complimentary with inner disk 233 ball bearing groove 239 is middle disk 235 inner ball bearing groove 241. Ball bearing groove 239 and ball bearing groove 241 complement each other and have ball bearings 243 to allow freewheeling between inner disk 233 and middle disk 235. Likewise middle disk 235 has an outer ball bearing groove 245. Ball bearing groove 245 complements the ball bearing groove 247 which is along the inner plane of outer disk 239. T-spacer 249 is affixed to the central part of middle disk 235. Cap 505 of spacer disk 249 is thicker then the thickness of attachment ring 226. In the center of cap 505 spacer disk 249 is a hollow 252 which receives attachment screw 251. (See details in FIG. 5) Assembled freewheeling plate bearing device 231 is received into hollow 219 created by housing cylinder 222.

Circular mounting plate 261 is affixed to freewheeling bearing device 231 by means of attachment screw 251 through mounting plate hole 263 into threaded hollow 252 in the center of cap 505 of T-spacer disk 249. Heat radiator plate 267 in cooperation with air vents 303 (See FIG. 1) radiates heat generated by wheel 101 and display. Mounted on circular mounting plate 261 is a rotation inhibiting mass 298. A battery holding 292 hollow is within rotation inhibiting mass 298. Cooling is likewise regulated by cooling heatsink 271. Cooling heatsink 271 is affixed to thermoelectric cooler 269 and radiator plate 267. Cooling heatsink 271 has an outer ridge 273 and an inner ridge 275. Affixed within the inner ridge 275 is the display 277. Video receiver 281 and display control 283 are placed between outer ridge 273 and inner ridge 275. Affixed within cooling heatsink 271 and connected to video receiver 281 and display control 283 is video display 277. When assembled the entire invention 201 is covered by Plexiglas cover 289. Plexiglas cover 289 is held in place by affixing means such as screws 291.

FIG. 5 shows detail of T-spacer 249. Cap 505 is shown in side view as A and top view as B. In the center 252 of cap 505 spacer disk 249 is a hollow 252 which receives attachment screw 251. Bolt finger 507 passes through central tunnel 509 of outer disk 239. Central tunnel 509 has a slightly larger diameter than diameter of finger bolt 507 to allow free rotation. As shown in side view A, finger bolt 507 terminates in bearing screw 511. Bearing screw 511 is threaded into bearing screw tap 503 in center of middle disk 235.

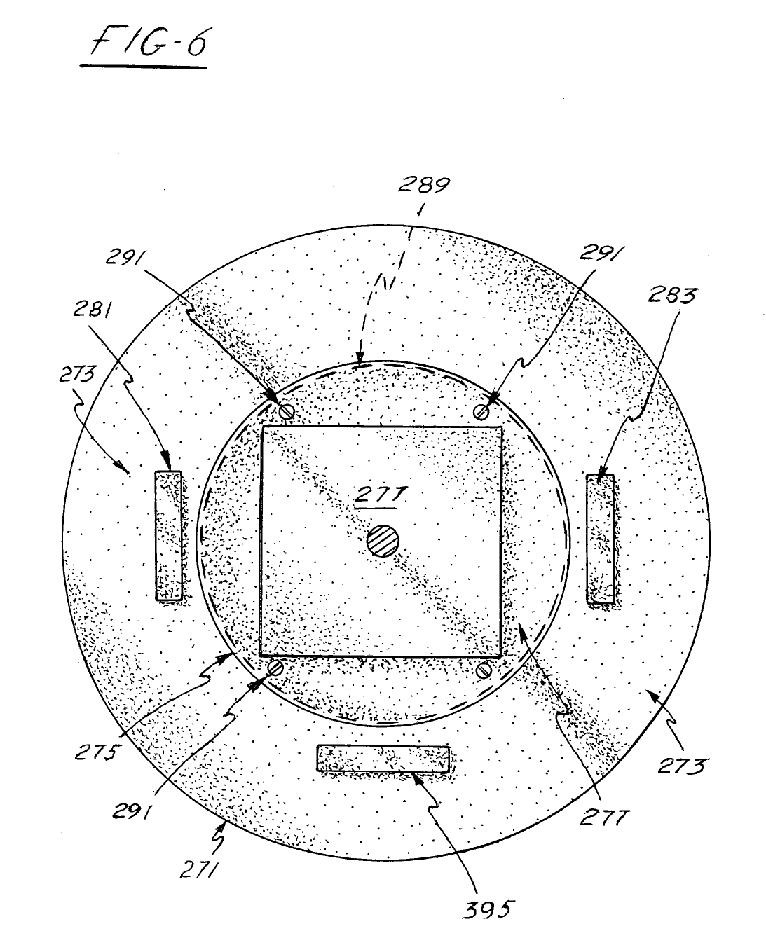

FIG. 6 shows head on view of heatsink 271. Cooling heatsink 271 has an outer ridge 273 and an inner ridge 275. Affixed within the inner ridge 275 is the display 277. Video receiver 281 and display control 283 are placed between outer ridge 273 and inner ridge 275. Plexiglas cover 289 (Shown in outline) is held in place by affixing means such as screws 291.

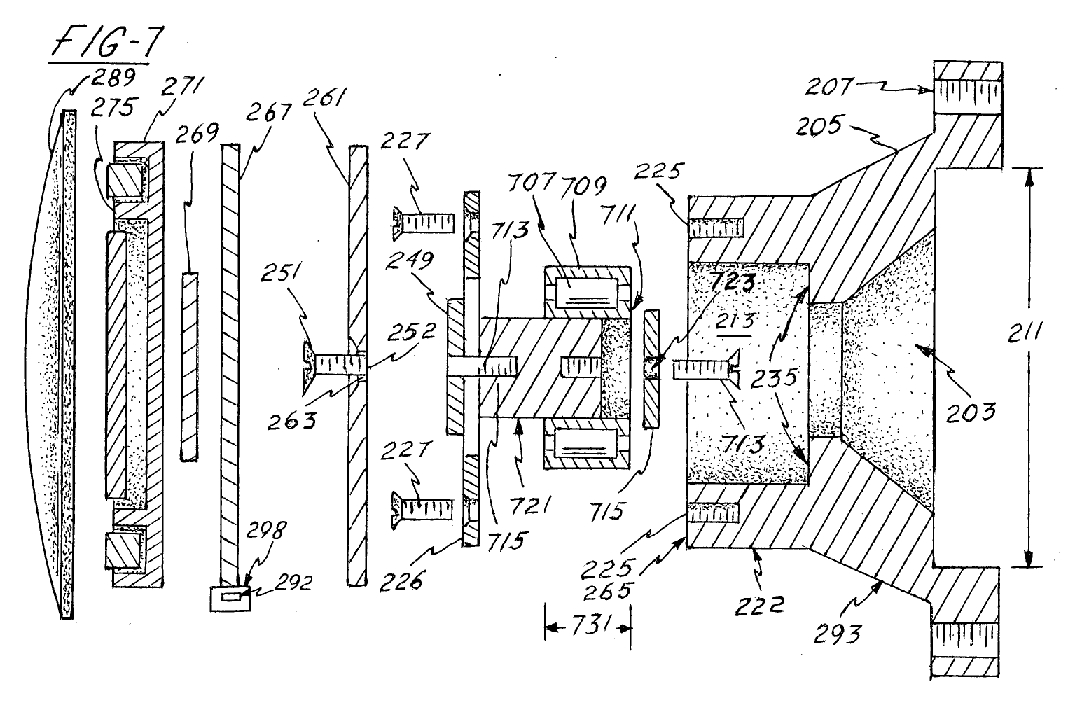

FIG. 7 shows an alternative bearing means, in this instance a roller bearing. Display wheel mount 293 cast section view shows display wheel mount 293 has cone cylinder 205 with axle depression void 211. Cone cylinder 205 has outer cylindrical extensions 221 with holes 207 for workpiece lug bolts 209. Inner side 203 of depression void 211 terminates in inner support 235 of axle depression base 213. Cone cylinder 205 has a first progression to make housing cylinder 222 which housing cylinder 222 surrounds free willing bearing device 731. Likewise, a second progression of cone cylinder 205 extends inwardly as inner support 235 of axle depression base. Housing cylinder 222 ends in housing cylinder mounting plane 265 which has screw holes 225.

Outer bearing race 709 complements inner bearing race 711 to enclose bearings 707. While bearing 707 is a roller bearing it is within the spirit of the invention to have ball bearings or tapered bearings. One or more roller bearing assemblies may be used. Internal cylinder 721 is internal relative to inner bearing race 711. Internal cylinder 721 is held within inner bearing race 711 by washer 715 and affixing screw 713. Bearing assembly 731 is held by attachment ring 226 which is affixed to mounting plane 265 of housing cylinder 222 with screws 227. Washer 715 is affixed by screw 713 which is twisted into first threaded hole 723 of internal cylinder 721 which affixes internal cylinder 721 to bearing 707.

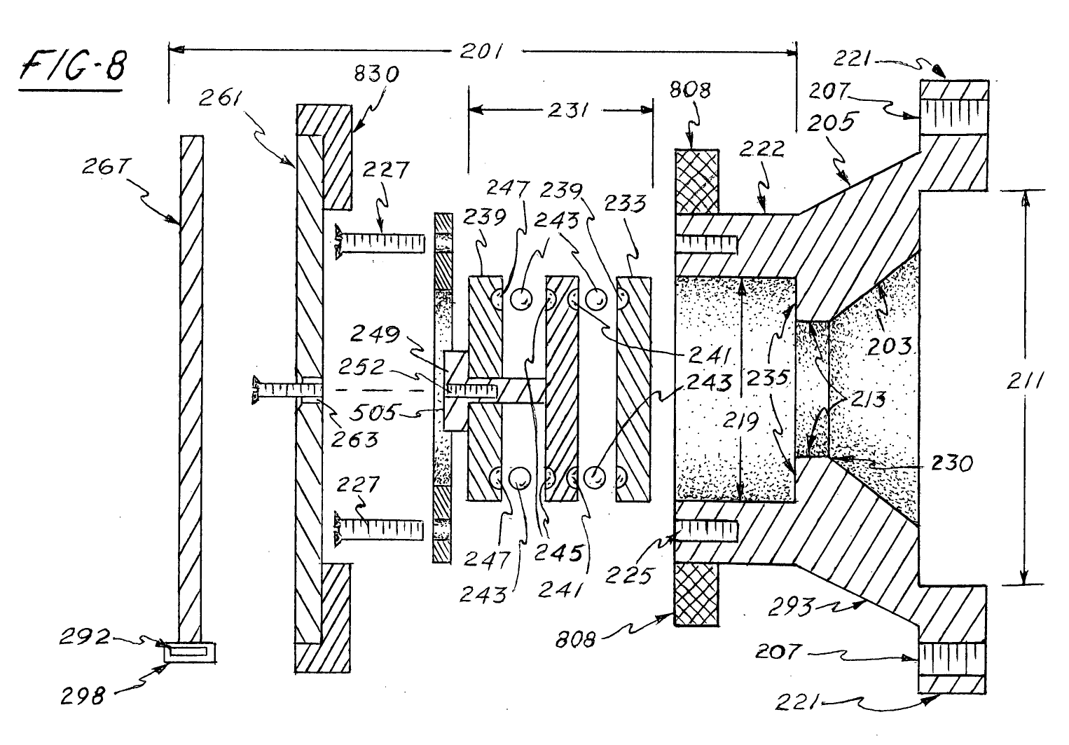

FIG. 8 shows an exploded view of the invention 201 similar to the view in FIG. 4. However, FIG. 8 illustrates an embodiment with a wheel movement powered generator for low power display. Display wheel mount 293 cast section view shows display wheel mount 293. Cone cylinder 205 has outer cylindrical extensions 221 with holes 207 for workpiece lug bolts 209. Inner side 230 of depression void 211 terminates in inner support 235. Cone cylinder 205 has a first progression to make housing cylinder 222 which housing cylinder 222 surrounds free willing bearing device 231. Likewise, a second progression of cone cylinder 205 extends inwardly as inner support 235 of axle depression base.

Affixed to and surrounding housing cylinder 222 is generator stator 808. Generator stator 808 has a series of permanent magnets. Housing cylinder 222 ends in housing cylinder mounting plane 265 which has screw holes 225. An addition or modification of circular mounting plate 261 is the rotors of wheel generator 830. A generator rotor has a wound series of electromagnets which generates electrical current necessary to operate cooling heatsink 271, display 277, video receiver 281 and display control 283.

Attachment ring 226 is affixed to mounting plane 265 of housing cylinder 222 with screws 227. Freewheeling plate bearing device 231 has an inner disk 233, a middle disk 235, and an outer disk 239. Inner disk 233 has a ball bearing groove 239. Complimentary with inner disk 233 ball bearing groove 239 is middle disk 235 inner ball bearing groove 241. Ball bearing groove 239 and ball bearing groove 241 complement each other and have ball bearings 243 to allow freewheeling between inner disk 233 and middle disk 235. Likewise middle disk 235 has an outer ball bearing groove 245. Ball bearing groove 245 complements the ball bearing groove 247 which is along the inner plane of outer disk 239. T-spacer 249 is affixed to the central part of inner disk 239. Cap 505 of spacer disk 249 is thicker then the thickness of attachment ring 225. In the center of cap 505 spacer disk 249 is a hollow 252 which receives attachment screw 251. (See detail in FIG. 5) Assembled freewheeling plate bearing device 231 is received into hollow 219 created by housing cylinder 222.

Circular mounting plate 261 is affixed to freewheeling bearing device 231 by means of attachment screw 251 through mounting plate hole 263 into threaded hollow 252 of outer disk 239. Heat radiator plate 267 in cooperation with air vents 303 (See FIG. 1) radiates heat generated by wheel 101. Mounted on heat radiator plate 267 is a rotation inhibiting mass 290. A battery holding 292 hollow is within rotation inhibiting mass 290. This battery receives current from generator rotor 826.

I claim:

1) A display construct that provides a moving picture or illustration on the hubcap of an automobile comprising:
a display wheel mount which has a cone cylinder and an axle depression void;
said cone cylinder has cylindrical extensions with holes for workpiece lug bolts;
said cone cylinder has a first progression to make housing cylinder;
which housing cylinder houses a free wheeling bearing device;
an attachment ring is affixed to mounting plane of housing cylinder to affix said free wheeling bearing device;
a circular mounting plate is affixed to freewheeling bearing device through mounting plate hole into a T spacer;
a thermoelectric cooler and radiator plate is affixed to said mounting plate;
a heatsink is affixes to said thermoelectric cooler and radiator plate;
said heatsink has an outer ridge and an inner ridge;
power means;
a video source;
placed within said inner ridge and said outer ridge is a video receiver and display control;
a video display is affixed on said heatsink;
a means to keep said video display in an updown position.
when said display construct is assembled entire invention is covered by a Plexiglas™ or Lexan™ cover;
said Plexiglas™ or Lexan™ cover is held in place by affixing means.

2) A display construct that provides a moving picture or illustration on the hubcap of an automobile as in claim 1) wherein said free wheeling bearing device is a plate bearing device.

3) A display construct that provides a moving picture or illustration on the hubcap of an automobile as in claim 1) wherein said free wheeling bearing device is a roller bearing.

4) A display construct that provides a moving picture or illustration on the hubcap of an automobile as in claim 1) wherein additional cooling means are vanes on the wheel

5) A display construct that provides a moving picture or illustration on the hubcap of an automobile as in claim 1) where in said power means is a dry battery.

6) A display construct that provides a moving picture or illustration on the hubcap of an automobile as in claim 1) wherein said power means is a wheel movement powered generator.

7) A display construct that provides a moving picture or illustration on the hubcap of an automobile as in claim 1) wherein said power means are slipring connectors with wires which terminates as inner contacts which allows power from the car battery.

8) A display construct that provides a moving picture or illustration on the hubcap of an automobile as in claim 1) wherein said video source is a video link to a VCR, DVD, or ordinary video TV as well as a computer video sources.

9) A display construct that provides a moving picture or illustration on the hubcap of an automobile as in claim 1) wherein said display control means is a manual control device or electronically controlled device via radio or infrared signals.

10) A display construct that provides a moving picture or illustration on the hubcap of an automobile as in claim 1) wherein said means to keep the video display in an updown position is a counterweight rotation inhibiting mass; or an electric motor timed to spin at the same time the wheel spins.

11) A display construct that provides a moving picture or illustration on the hubcap of an automobile as in claim 1) wherein said displays of detailed illustrations on the surface of hubcaps use light emitting diodes (LEDS), liquid crystal displays (LCD) or digital light processing displays (DLP).
